(19) United States
(12) Patent Application Publication
(10) Pub. No.: US 2011/0090163 A1
(43) Pub. Date: Apr. 21, 2011

(54) METHOD AND APPARATUS FOR MANAGING TOUCH FUNCTION IN A PORTABLE TERMINAL

(75) Inventor: Seung-Jun LEE, Suwon-si (KR)

(73) Assignee: SAMSUNG ELECTRONICS CO. LTD., Suwon-si (KR)

(21) Appl. No.: 12/902,560

(22) Filed: Oct. 12, 2010

(30) Foreign Application Priority Data
Oct. 15, 2009 (KR) 10-2009-0098142

(51) Int. Cl. G06F 3/041

(52) U.S. Cl. 345/173

(57) ABSTRACT

A method and apparatus for managing a touch function in a portable terminal are provided. The method includes determining if an input is received during a preset time, when the input is not received during the preset time, driving a proximity sensor and determining if an object exists around the portable terminal, and maintaining ON or turning OFF a touch recognition function of a touch sensor depending on whether the object exists around the portable terminal.

### PRIORITY

This application claims the benefit under 35 U.S.C. § 119(a) of a Korean patent application filed in the Korean Intellectual Property Office on Oct. 15, 2009 and assigned Serial No. 10-2009-0098142, the entire disclosure of which are herein incorporated by reference.

### BACKGROUND OF THE INVENTION

1. Field of the Invention

The present invention relates to a method and apparatus for managing a touch function in a portable terminal. More particularly, the present invention relates to a method and apparatus for turning ON/OFF a touch recognition function of a touch sensor in a portable terminal.

2. Description of the Related Art

Today, as advances are made in the field of Information Telecommunication (IT) technology, especially in the fields regarding the Internet and computers, many portable terminals complying with various preferences and demands of consumers are produced and supplied. For an example, portable terminals with touch screens are widely supplied.

By recognizing a user's touch operation through a touch sensor and performing a corresponding function, a portable terminal with a touch screen has an advantage of being capable of performing various functions after receiving only a user's touch on a screen. However, the portable terminal also has a disadvantage in that an unintended operation may be erroneously recognized by the portable terminal as a touch. For example, it frequently occurs that the portable terminal performs an unintentional operation based on the erroneous recognition of a user's face touching the screen during a call as a user's touch operation or erroneously recognizes a surrounding object touching the screen as a touch operation when a user keeps the portable terminal in a pocket or bag.

More particularly, in recent years, the number of portable terminals using a C-type touch screen is increasing and thus, the probability of erroneously recognizing a touch is increasing. Here, the C-type touch screen is a touch screen that more simply recognizes an operation of touching a screen. That is, compared to an R-type touch screen that detects a press of a Z-axis and recognizes only a touch accompanied with the press of the Z-axis, the C-type touch screen has a higher touch sensitivity, but has a higher erroneous recognition rate because, when there is even a slight touch on the screen, it is recognized as a touch operation.

Accordingly, the conventional art provides a technique for turning OFF a touch recognition function using a specific key (e.g., a lock key) in a portable terminal and a technique of, in case that a face touches a screen during a call, turning OFF a touch recognition function using a proximity sensor.

However, although the above techniques are provided in the portable terminal, it frequently occurs that many users keep portable terminals in their pockets or bags without turning OFF the touch recognition function. Thus, the portable terminal still performs an erroneous operation due to surrounding objects in the pocket or bag. Moreover, there is a problem that, in an environment in which it is possible to enter an idle mode, the portable terminal fails to enter the idle mode due to an erroneous touch and instead maintains an awake state, thus increasing current consumption.

### SUMMARY OF THE INVENTION

An aspect of the present invention is to address at least the above problems and/or disadvantages and to provide at least the advantages below. Accordingly, an aspect of the present invention is to provide a method and apparatus for turning ON/OFF a touch recognition function of a touch sensor in a portable terminal.

Another aspect of the present invention is to provide a method and apparatus for turning ON/OFF a touch recognition function of a touch sensor using a proximity sensor in a portable terminal.

A further aspect of the present invention is to provide a method and apparatus for turning ON/OFF a touch recognition function of a touch sensor when idle mode entry is determined in a portable terminal.

The above aspects are achieved by providing a method and apparatus for managing a touch function in a portable terminal

According to an aspect of the present invention, a method for managing a touch function in a portable terminal is provided. The method includes determining if an input is received during a preset time, when the input is not received during the preset time, driving a proximity sensor and determining if an object exists around the portable terminal, and maintaining ON or turning OFF a touch recognition function of a touch sensor depending on whether the object exists around the portable terminal.

According to another aspect of the present invention, an apparatus for managing a touch function in a portable terminal is provided. The apparatus includes a touch sensor, a proximity sensor, and a controller. The touch sensor recognizes a touch. The proximity sensor determines if an object exists around the portable terminal When an input is not received during a preset time, the controller drives the proximity sensor to determine if an object exists around the portable terminal, and maintains ON or turns OFF a touch recognition function of a touch sensor depending on whether the object exists around the portable terminal

According to yet another aspect of the present invention, a method for managing a touch function in a portable terminal is provided. The method includes determining if an input is received, when the input is not received, determining if an object exists around the portable terminal, and, if the object exists around the portable terminal, turning OFF the touch recognition function.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a block diagram illustrating a construction of a portable terminal according to an exemplary embodiment of the present invention; and

FIG. 2 is a flowchart illustrating a procedure for managing a touch function in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following description is made for a method and apparatus for turning OFF a touch recognition function of a touch sensor using a proximity sensor in a portable terminal according to the present invention. Here, the term “portable terminal” denotes any terminal with a touch screens including a mobile communication terminal, a Personal Digital Assistant (PDA), a Portable Multimedia Player (PMP), a digital camera, a portable game machine, an MPEG Audio Layer-3 (MP3) player, and the like.

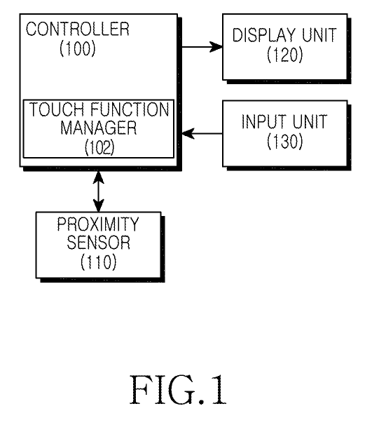

FIG. 1 is a block diagram illustrating a construction of a portable terminal according to an exemplary embodiment of the present invention.

Referring to FIG. 1, the portable terminal includes a controller 100, a proximity sensor 110, a display unit 120, and an input unit 130. The controller 100 includes a touch function manager 102.

The controller 100 controls and processes a general operation of the portable terminal. More particularly, by including the touch function manager 102, the controller 100 controls and processes a function for maintaining ON or turning OFF a touch recognition function of a touch sensor depending on whether an object exists around the portable terminal when the portable terminal enters an idle mode.

That is, when an input to the portable terminal does not exist during a preset time, for example, when a touch or key press by a user is not generated or a call is not generated to or from a network, the touch function manager 102 of the controller 100 determines that the portable terminal may enter an idle mode and, by driving the proximity sensor 110, determines if an object exists around the portable terminal If a signal representing that an object exists around the portable terminal is provided from the proximity sensor 110, the touch function manager 102 controls to process a function for turning OFF (or locking) a touch recognition function of a touch sensor and enters the idle mode. On the contrary, if a signal representing that an object does not exist around the portable terminal is provided from the proximity sensor 110, the touch function manager 102 controls to process a function for maintaining the touch recognition function of the touch sensor in the ON state and enters the idle mode.

In an exemplary implementation, the proximity sensor 110 determines if an object exists around the portable terminal using an electromagnetic field, and provides the determined result to the controller 100. The sensitivity of the proximity sensor 110 may be set by a manufacturer and later changed by a user so that the distance at which the proximity sensor 110 senses an object may be changed. Moreover, it is to be understood that the term “around” denotes an object in the proximity of or otherwise nearby the portable terminal.

The display unit 120 displays state information generated during an operation of the portable terminal. For example, the display unit may display information including a numeral, a character, a moving picture, a still picture, etc. The display unit 120 can be a display device such as a Liquid Crystal Display (LCD), an Organic Light Emitting Diode (OLED), and the like.

The input unit 130 includes a touch sensor (not shown) for recognizing a user's touch operation and a key input unit (not shown) including at least one of numeral, character, and function keys. The input unit 130 provides data corresponding to a user's touch or key input, to the controller 100. For example, the input unit 130 recognizes a touch scheme (e.g., a touch position, a touch direction, a touch shape, the number of times of touch, and the like) in which a user touches a screen, and provides corresponding data to the controller 100. The input unit 130 also detects an input of a lock key for turning OFF the touch recognition function of the touch sensor and provides corresponding data to the controller 100.

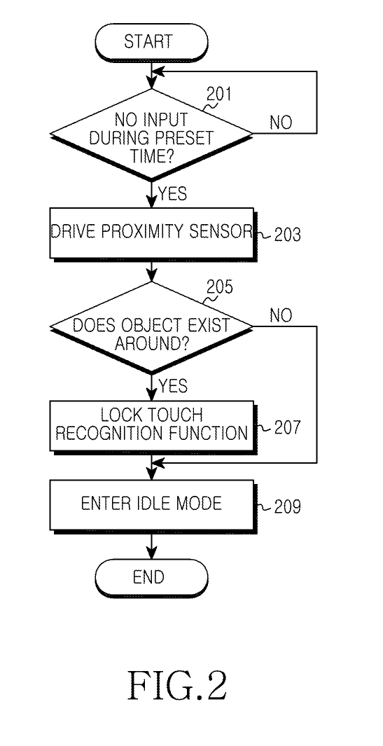

FIG. 2 is a flowchart illustrating a procedure for managing a touch function in a portable terminal according to an exemplary embodiment of the present invention.

Referring to FIG. 2, the portable terminal determines if an input is received during a preset time in step 201. If it is determined in step 201 that an input is not received during the preset time, the portable terminal proceeds to step 203 and drives a proximity sensor. For example, when a touch or key press by a user is not generated or a call is not generated to or from a network during a preset time, the portable terminal drives the proximity sensor. Here, the preset time is a time that is a criterion of idle mode entry. When any input to the portable terminal is not received during the preset time, the portable terminal determines to enter an idle mode. The preset time may be set by the manufacturer and changed by the user.

In step 205, the portable terminal determines if an object exists around the portable terminal through the proximity sensor. In an exemplary implementation, the proximity sensor determines if an object exists around the portable terminal using an electromagnetic field.

If it is determined in step 205 that the object exists around the portable terminal, the portable terminal proceeds to step 207 and turns OFF (or locks) a touch recognition function of a touch sensor. In step 209, the portable terminal enters the idle mode. Then, the portable terminal terminates the procedure according to the exemplary embodiment of the present invention.

In contrast, if it is determined in step 205 that the object does not exist around the portable terminal, the portable terminal proceeds directly to step 209 and enters the idle mode without turning OFF the touch recognition function of the touch sensor. Then, the portable terminal terminates the procedure according to the exemplary embodiment of the present invention.

As described above, the present invention determines whether an object exists around a portable terminal before the portable terminal enters an idle mode and, in case that the object exists around the portable terminal, turns OFF a touch recognition function of a touch sensor. By doing so, although a user keeps the portable terminal in a pocket or bag without turning OFF the touch recognition function through a specific key, the present invention can turn OFF the touch recognition function, thus preventing the occurrence of an erroneous operation.

Exemplary embodiments of the present invention maintain ON or turn OFF a touch recognition function of a touch screen using a proximity sensor if it is determined that a portable terminal desires to enter an idle mode. By doing so, erroneous operation of the portable terminal caused by erroneous touch recognition is reduced and power consumption is reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for managing a touch function in a portable terminal, the method comprising:
determining if an input is received during a preset time;
when the input is not received during the preset time, driving a proximity sensor and determining if an object exists around the portable terminal; and
maintaining ON or turning OFF a touch recognition function of a touch sensor depending on whether the object exists around the portable terminal.

2. The method of claim 1, wherein the maintaining ON or the turning OFF of the touch recognition function comprises:
when the object exists around the portable terminal, turning OFF the touch recognition function; and
when the object does not exist around the portable terminal, maintaining ON the touch recognition function.

3. The method of claim 1, further comprising, after the maintaining ON or the turning OFF of the touch recognition function, entering an idle mode.

4. The method of claim 1, wherein the input comprises at least one of a screen touch by a user, a key press, and reception of a call from a network.

5. An apparatus for managing a touch function in a portable terminal, the apparatus comprising:
a touch sensor for recognizing a touch;
a proximity sensor for determining if an object exists around the portable terminal; and
a controller for, when an input is not received during a preset time, driving the proximity sensor to determine if an object exists around the portable terminal, and for maintaining ON or turning OFF a touch recognition function of a touch sensor depending on whether the object exists around the portable terminal.

6. The apparatus of claim 5, wherein, when the object exists around the portable terminal, the controller turns OFF the touch recognition function and, when the object does not exist around the portable terminal, maintains ON the touch recognition function.

7. The apparatus of claim 5, wherein, after maintaining ON or turning OFF the touch recognition function, the controller enters an idle mode.

8. The apparatus of claim 5, wherein the controller determines if the input is received during the preset time by determining if at least one of a screen touch by a user, a key press, and reception of a call from a network is generated during the preset time.

9. A method for managing a touch function in a portable terminal, the method comprising:
determining if an input is received;
when the input is not received, determining if an object exists around the portable terminal; and
if the object exists around the portable terminal, turning OFF the touch recognition function.

10. The method of claim 10, wherein, if the object does not exist around the portable terminal, maintaining ON the touch recognition function.

11. The method of claim 9, further comprising, after the turning OFF of the touch recognition function, entering an idle mode.

12. The method of claim 10, further comprising, after the maintaining ON of the touch recognition function, entering an idle mode.

13. The method of claim 9, wherein the input comprises at least one of a screen touch by a user, a key press, and reception of a call from a network.
